(19) United States
(12) Patent Application Publication
(10) Pub. No.: US 2007/0103483 A1
(43) Pub. Date: May 10, 2007

(54) Adaptive alpha blending

(75) Inventor: Peter Glen, Venice, FL (US)

Correspondence Address: BROOKS KUSHMAN P.C., 1000 TOWN CENTER, TWENTY-SECOND FLOOR, SOUTHFIELD, MI, 48075, US

(73) Assignee: Steven J. Feldman

(21) Appl. No.: 11/185,334

(22) Filed: Jul. 20, 2005

(51) Int. Cl. G09G 5/02

(52) U.S. Cl. 345/592

(57) ABSTRACT

Methods for processing a first image which has a plurality of pixels. One method processes the first image by obtaining (105) a first value of a pixel, determining (110) whether the first value is in a first predetermined relationship with a blending threshold and, if so, designating (115) the pixel to be an opaque pixel, determining (120) whether the first value is in a second predetermined relationship with a transparency threshold and, if so, designating (125) the pixel to be a transparent pixel, and otherwise, designating (130) the pixel to be a partially transparent pixel and determining the degree of transparency. The processed first image is then superimposed upon a second image to provide a composite image.

### BACKGROUND OF THE INVENTION

1. Field of the Invention

(1) The present invention relates to alpha blending of images and, more particularly, to removal of artifacts from an image for blending.

2. Description of the Related Art

When creating or annotating an image, one frequently encounters the need to superimpose one or more smaller foreground images on top of a generally more complex and larger background image. Ideally, a foreground image would be superimposed on the background image in a manner such that the resulting composite image is as realistic and lifelike as possible.

In the process of applying the foreground image, however, inconsistencies may occur, and artifacts are frequently introduced. This is especially true when the foreground image is resized and/or rotated. Anti-aliasing processes may introduce even more artifacts.

For instance, if one has an underlying background image, such as a dental X-Ray photograph, and one pastes a foreground image transparently therein, such as a picture of a dental implant, then significant deterioration of the composite image can occur. The foreground implant image may become blurred around the edges, new pixels may be created which are all white, some existing pixels may become all white, transparency may be adversely affected, and the resulting composite image may become unsatisfactory.

Alpha blending is a process of displaying one or more pixels in a foreground image transparently. The alpha (transparency) value for a foreground pixel ranges from 0 to 255. If alpha is zero the foreground pixel is completely transparent and passes the background pixel, i.e., the background pixel shows through. If alpha is 255 the foreground pixel is completely solid or opaque and the foreground pixel completely blocks the background pixel. If alpha is between these two values the resulting pixel is a blend of the foreground and background pixels, and the degree of contribution by the foreground and background pixels is determined by the alpha value of the foreground pixels.

It is possible to perform alpha blending manually, such as by visually inspecting each pixel, making a decision as to the desired transparency (or, inversely, the opacity) of the pixel, and then manually setting the alpha value for that pixel to produce the desired transparency. This is done on a pixel-by-pixel basis, is time-consuming, expensive, tedious, subject to human error, and very subjective and inconsistent due to the variable perception and fatigue of the human operator, especially where large pictures, many pictures and/or many foreground images are involved.

### BRIEF SUMMARY OF THE INVENTION

The present invention provides for automatically removing or reducing the artifacts from a desired foreground image for superimposing the foreground image onto a desired background image.

One embodiment of the present invention provides a method for processing a first image which has a plurality of pixels. The method includes obtaining a first value of a pixel, if the first value is in a first predetermined relationship with a blending threshold then designating the pixel to be an opaque pixel, if the first value is in a second predetermined relationship with a transparency threshold then designating the pixel to be a transparent pixel, otherwise, designating the pixel to be a partially transparent pixel, and repeating the steps for at least one other pixel.

Another embodiment of the present invention provides another method for processing a first image which has a plurality of pixels. The method includes obtaining the color values of a pixel, if the color values are in a first predetermined relationship with a blending threshold then designating the pixel to be an opaque pixel, if the color values are in a second predetermined relationship with a transparency threshold then designating the pixel to be a transparent pixel, otherwise, designating the pixel to be a partially transparent pixel, and repeating the steps for at least one other pixel.

Still another embodiment of the present invention provides a method for combining a first image and a second image, each image having a plurality of pixels. The method includes obtaining a first value of a pixel of the first image, if the first value is in a first predetermined relationship with respect to a blending threshold then designating the pixel to be an opaque pixel which blocks the corresponding pixel of the second image, if the first value is in a second predetermined relationship with respect to a transparency threshold then designating the pixel to be a transparent pixel which passes the corresponding pixel of the second image, otherwise, designating the pixel to be a partially transparent pixel which passes a portion of the corresponding pixel of the second image, and repeating the steps for at least one other pixel of the first image and the second image.

Still another embodiment of the present invention provides another method for combining a first image and a second image, each image having a plurality of pixels. The method includes obtaining the color values of a pixel of the first image, if the color values are in a first predetermined relationship with a blending threshold then designating the pixel to be an opaque pixel which blocks the corresponding pixel of the second image, if the color values are in a second predetermined relationship with a transparency threshold then designating the pixel to be a transparent pixel which passes the corresponding pixel of the second image, otherwise, designating the pixel to be a partially transparent pixel which passes a portion of the corresponding pixel of the second image, and repeating the steps for at least one other pixel of the first image and the second image.

Other objects, features, benefits and advantages of the present invention will become apparent upon reading the following description of the preferred embodiment, when taken in conjunction with the drawings and the claims.

### BRIEF DESCRIPTION OF THE SEVERAL VIEWS OF THE DRAWING

FIG. 1 is a flow chart illustrating a process of preparing a foreground image.

FIG. 2 is a flow chart illustrating a process of creating of creating a composite image.

FIG. 3 which is an example of an application of the process of the present invention.

FIG. 4 is an illustration of a typical operating environment for an embodiment of the present invention.

### DETAILED DESCRIPTION OF THE INVENTION

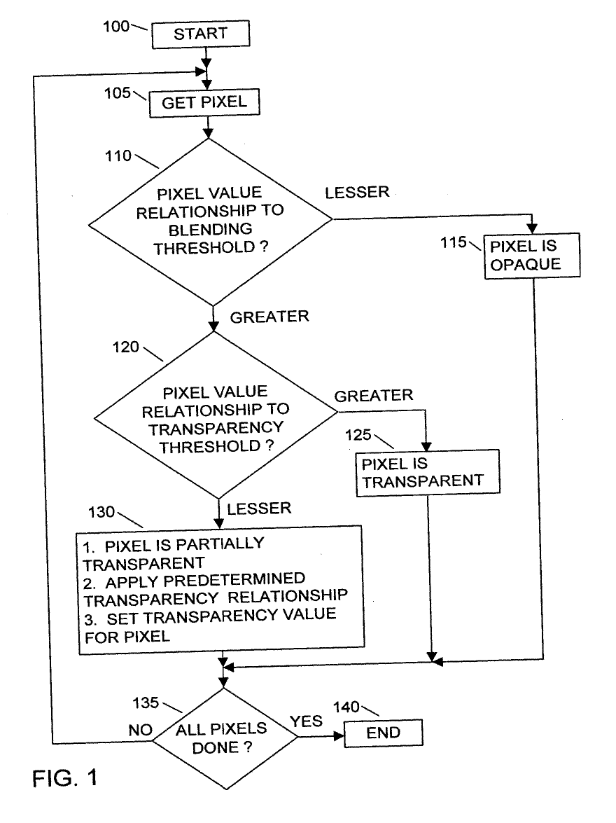

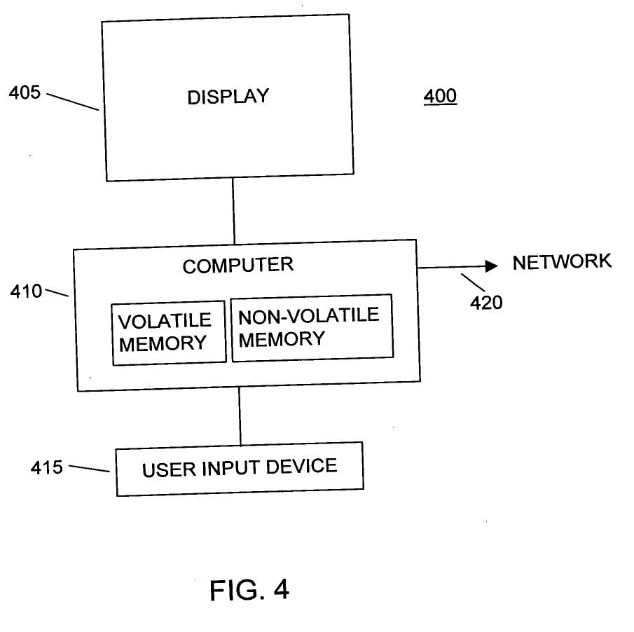

FIG. 1 is flow chart illustrating a process of preparing a foreground image. This process is preferably performed by a computer or other data processing device, such as illustrated in FIG. 4. Upon starting 100, a pixel is obtained 105. Decision 110 evaluates the relationship of the pixel value to the blending threshold. In the example shown, the relationship is evaluated by comparing the pixel value to the blending threshold to determine whether the pixel value is less than the blending threshold. Thus, if the pixel value is less than the blending threshold then the pixel is designated to be opaque, that is, the transparency is set to 255, and the process then proceeds to step 135.

If the pixel value is greater than the blending threshold, then decision 120 evaluates the relationship of the pixel value to the transparency threshold. In the example shown, the relationship is evaluated by comparing the pixel value to the transparency threshold to determine whether the pixel value is greater than the transparency threshold. Thus, if the pixel value is greater than the transparency threshold then the pixel is designated to be transparent, that is, the transparency is set to 0, and the process then proceeds to step 135.

If the pixel value is less than the transparency threshold then in step 130 the pixel is designated to be partially transparent. A predetermined transparency relationship among the pixel value, the blending threshold, and the transparency threshold is then evaluated to determine the transparency value for the pixel, and that pixel is set to that determined transparency value.

Decision 135 then tests whether all of the desired pixels in the foreground image have been evaluated. If not, then a return is made to step 105 to get the next pixel. If all pixels have been evaluated, then this process ends 140.

From the above, it will be appreciated that, as the value of the foreground pixel moves away from the blending threshold and approaches the transparency threshold, the pixel become more and more transparent—that is, the resulting composite pixel has an increasing percentage from the underlying background picture and a decreasing percentage from the foreground image. This provides for a smooth transition at the edges between the foreground object and the background object, thereby yielding a cleaner object contour on the composite image.

The graduation from opaque to transparent may be linear between the two thresholds, or may follow any desired equation, power law, or function. Thus, the predetermined transparency relationship may be any desired relationship: fixed, linearly variable, or non-linearly variable. As one fixed relationship example, if the pixel value is between the blending threshold and the transparency threshold then the transparency may be a fixed value, e.g., 127 (approximately 50% on a range of 0 to 255), or any other desired or appropriate transparency value. As one linear relationship example, if the blending threshold is 220 and the transparency threshold is 250, and the pixel value is 230, then the transparency would be one-third ((230−220)/(250 −220)), or approximately 85 on a range of 0 to 255. As one non-linear relationship example, for example, a power relationship, if the blending threshold is 220 and the transparency threshold is 250, and the pixel value is 230, then the transparency would be one-ninth ((230−220)/(250 −220))², or approximately 28 on a range of 0 to 255. A non-linear relationship need not be continuous, but may be discontinuous, and use step or other functions to achieve different effects. Other fixed, linear, and non-linear relationships are also possible.

The above discussion treats a pixel value as if it were single number, which may be the case in some systems, such as, but not limited to, “black and white only’ systems. Many systems, however, are capable of handling color images or pictures, so slightly different processing is warranted. A typical color picture is an array of pixels, wherein each pixel has RGB (red, green, blue) values, with each value having a range of 0 (minimum) to 255 (maximum), and any desired color can be described by appropriate discrete RGB values.

For “black and white” systems, or foreground images, the RGB values will be equal, e.g., pure black is RGB(0, 0, 0), pure white is RGB(255, 255, 255), and shades of gray are RGB(N, N, N), where N is a number between 0 and 255, for example, all three (RGB) values may be 59, or all three may be 128, or all three may be 235, etc. Thus, any of the RGB values, or any combination of them, or any composite of them, may be used as the pixel value for the comparison with the blending and transparency thresholds in connection with black and white systems and/or images.

In the case of a color system, however, especially where the foreground image is a color image, then the color values may not necessarily be equal, but may differ, sometimes dramatically. In the case of such color systems other options are available. Preferably, any foreground pixel that has all three color components larger than the transparency threshold will be transparent (alpha=0) so that the background pixel shows through; and any foreground pixel that has all three color components less than the blending threshold will be opaque (alpha 25=255) so that the foreground pixel completely hides the background pixel.

As other examples, the highest value of the color values may be used for the comparison with the thresholds, or the lowest value of the color values may be used for the comparison, or the intermediate value of the color values may be used for the comparison, or the average or median of the two higher values of the color values may be used for the comparison, or the average or median of the two lower values of the color values may be used for the comparison, or the average or median of the highest and lowest values of the color values may be used for the comparison, or the average or median of all color values may be used for the comparison. Other variations are also possible, e.g., the pixel value used for the comparison may be the sum of 50% of the R value, 35% of the G value, and 15% of the B value. The pixel value used for the comparison may also be some desired linear or non-linear function of the color values, etc. Thus, decisions 110 and 120 evaluate the relationship among the color values and the thresholds to determine the proper transparency value for that pixel.

Although an RGB color system has been described above, there are other color systems, and the present invention may be used with those as well. Therefore, the present invention should not be construed as being only for RGB color systems.

Thus, based upon an evaluation of the relationship among a pixel, a blending threshold, and a transparency threshold, a pixel is then designated as opaque, transparent, or partially transparent and, if partially transparent, the transparency value for that pixel is set according to a predetermined transparency relationship.

Once the foreground image has been processed to determine the transparency of each pixel, or even as each pixel of the foreground image is processed to determine its transparency, then the foreground image may be superimposed on the background image to yield the resultant composite image. Any foreground pixel that has a value less than the blending threshold will be displayed solid (i.e., alpha=255), and the foreground pixel will completely dominate and hide or block the background pixel in the resulting composite pixel. Conversely, any foreground pixel that has a value greater than the transparency threshold will be transparent (i.e., alpha=0), and the foreground pixel will not be displayed, and the background pixel will be passed and completely dominate the resulting composite pixel.

If a pixel has a value which is the same as a threshold value then it is a mere matter of preference as to whether that pixel will be treated as if its value were greater than the threshold value or less than the threshold value.

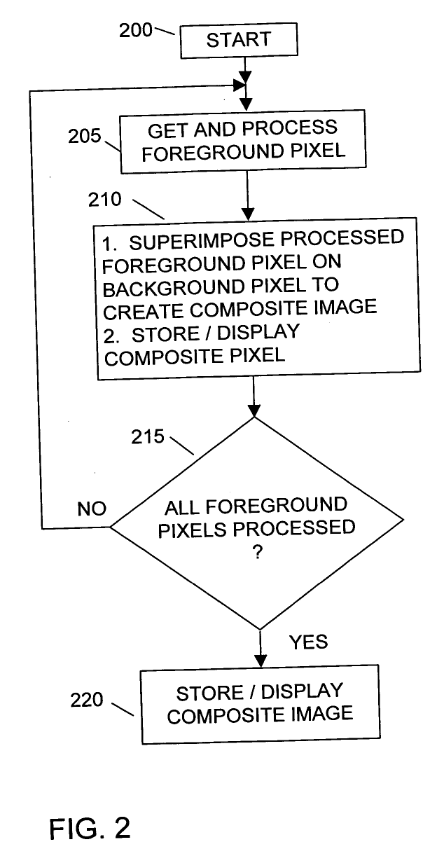

Turn now to FIG. 2, which is a flow chart illustrating a process of creating of creating a composite image. Upon starting 200, a foreground pixel 205 is processed to determine its transparency value, as described in FIG. 1. In step 200 the processed foreground pixel is then superimposed on the background pixel to create a composite pixel, which is then stored and/or displayed.

Decision 215 tests whether all of the foreground pixels have been processed. If not, a return is made to step 205 to process the next foreground pixel. If all the foreground pixels have been processed then the resulting composite image is stored and/or displayed.

It is a matter of design choice as to whether the composite image is altered, stored and displayed as each foreground pixel is processed, or whether the composite image is altered and stored, but not displayed, until all of the foreground pixels have been processed.

Although the above has described storing composite pixels and/or images as created, the present invention is not so limited. The present invention may be used in “on the fly” systems wherein a composite image is created but not necessarily saved at that time, e.g., it only exists in volatile memory until such time, if any, that it is saved into a non-volatile memory, such as a hard drive, CD, DVD, flash memory, etc. This is preferred in most situations as there is generally no need to store intermediate composite images in non-volatile memory. This is also useful in “live” situations, such as seminars or other presentations, where it is desired to show a composite pixel or image, but it is not desired to use non-volatile memory to save the composite image.

Also, although the above has referred to superimposing a smaller foreground image onto a larger background image, the present invention is not so limited, i.e., the foreground image may be larger than the background image or the same size as the background image.

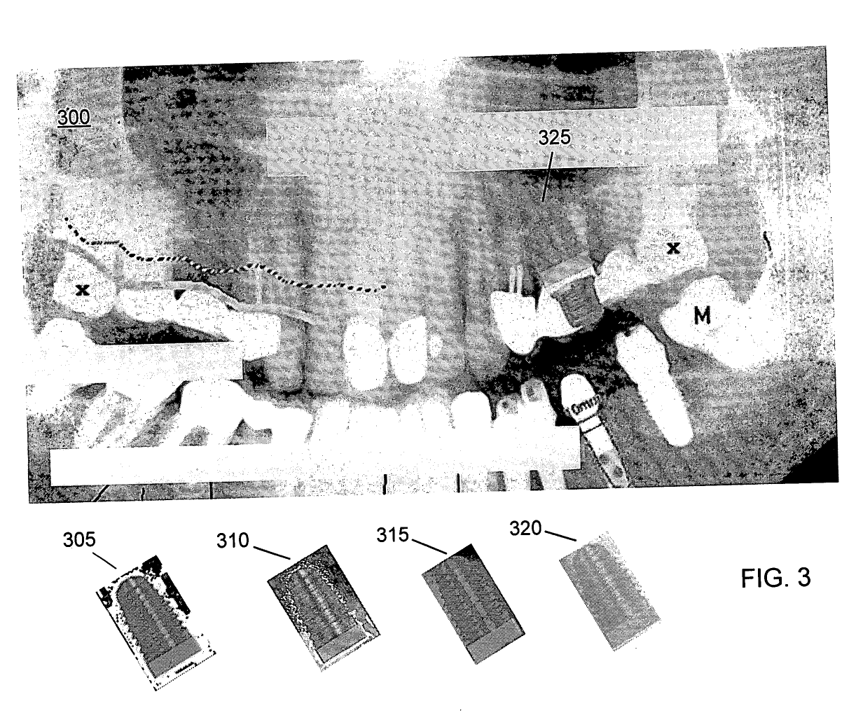

Turn now to FIG. 3 which is an example of an application of the process of the present invention. In this example it is desired to show a dental implant image 305 superimposed onto an X-ray picture 300 of a patient's mouth. Note that the dental implant image 305 has artifacts (white areas, speckled areas, and gaps or holes) associated therewith, which may be due to the image being used and/or due to rotation and/or scaling of the image. If the image 305 were merely placed into the desired position on the picture 300 then the artifacts would obscure part of the detail of the dental and bone structure and prevent a realistic view of the installed implant. Therefore, the user has two controls (threshold blend level, transparency blend level) which may be adjusted to reduce or eliminate these artifacts and provide the desired transitional blending between the foreground image and the underlying background picture. Images 310, 315 and 320 show the effects of differing threshold levels. For convenience of illustration, images 305, 310, 315 and 320 are shown below the picture 300. However, in practice, it is preferred that the desired foreground image be rotated, sized, cropped and/or placed into the desired position before the processing of the foreground image. This allows the user to see the resulting composite image. Thus, if a particular combination of threshold settings does not give the desired result, the user can adjust one or both of the threshold settings and see the new result. This can be easily repeated until the desired effect has been obtained and the composite image is deemed to be satisfactory by the user.

Once the desired effect or result has been obtained, the composite image is saved. Although this desired effect or result is still somewhat subjective, i.e., the user decides what threshold settings give the best visual result for the composite image, the result is consistent for all the pixels in the image. For example, as the processing is preferably for the entire foreground image, the user will not skip a pixel or pixels, or inadvertently label a pixel or pixels as transparent or partially transparent when they should be opaque, or assign the wrong degree of transparency. Further, the threshold settings can be saved, and quickly applied to a plurality of foreground images, rather than the user having to independently process each pixel of each foreground image. In addition, saving the threshold settings provides for consistency for later applications of similar foreground images to a background image.

Simply using a single threshold and then setting a pixel as transparent or opaque based on that threshold can result in a harsh and unrealistic composite image. The use of two thresholds with a partial transparency transition region between them provides for a more satisfactory composite image.

In an alternative embodiment, only the blending threshold is user adjustable, and the transparency threshold is fixed. In another alternative embodiment, only the transparency threshold is user adjustable, and the blending threshold is fixed. In still another alternative embodiment, there is only one threshold, the blending threshold, and pixels below the blending threshold are opaque, and pixels above the blending threshold are partially transparent/transparent, the upper limit on a pixel value (e.g., RGB(255, 255, 255)) being considered to an implied transparency threshold so that a pixel above the blending threshold will be more transparent as its value approaches the upper limit.

In some cases a reversed (negative) foreground image is used, the artifacts may be dark areas, rather than white ones. Therefore, in an alternative embodiment, the two thresholds are at the lower end of the scale. That is, the transparency threshold is nearer to 0 than the blending threshold. In this alternative embodiment, a pixel which has a value greater than the blending threshold will be designated to be opaque, a pixel which has a value less than the transparency threshold will be designated to be transparent, and a pixel which a value between those two thresholds will be designated to be partially transparent.

In still another alternative embodiment, there are blending and transparency thresholds at both ends of the scale. For example, if a pixel is almost pure white or almost pure black then it is probably an artifact and so will be designated to be transparent; if a pixel is between the two blending thresholds then it will be designated to be opaque and, otherwise, the pixel will be designated to be partially transparent.

FIG. 4 is an illustration of a typical operating environment for an embodiment of the present invention. A processing system 400 preferably comprises a display 405 whereby the user can view the composite image, a computer 410 for performing processing on the images, a user input device 415 whereby the user can input instructions, and a network connection 420 for connecting the system to other devices and/or data. The display 405 is preferably, but not necessarily, a color display. The computer 410 includes both volatile memory and non-volatile memory, non-volatile memory including, but not limited to, hard drives, floppy drives, CD and DVD drives, and flash memory, whether internal, external, or removable. The user input device 415 is preferably, but not necessarily, a keyboard and a mouse, and may also include a touchpad. It will be appreciated that the display 405 and the user input device 415 may be the same device, such as a touch-sensitive screen.

From a reading of the description above of the preferred and various alternative embodiments of the present invention described in detail herein, modifications and variations thereto may occur to those skilled in the art without departing from the spirit of the present invention. Therefore, the scope of the present invention is as set forth by the claims below.

I claim:

1. A method for processing a first image comprising a plurality of pixels, the method comprising the steps of:
(a) obtaining a first value of a pixel;
(b) if the first value is in a first predetermined relationship with a blending threshold then designating the pixel to be an opaque pixel;
(c) if the first value is in a second predetermined relationship with a transparency threshold then designating the pixel to be a transparent pixel;
(d) otherwise, designating the pixel to be a partially transparent pixel; and
(e) repeating steps (a) through (d) for at least a second pixel.

2. The method of claim 1 wherein the step of designating the pixel to be a partially transparent pixel comprises selecting a transparency value for the pixel based upon a predetermined transparency relationship for the transparency value with respect to the first value of the pixel and at least one of the blending threshold or the transparency threshold.

3. The method of claim 2 wherein the predetermined transparency relationship is a fixed relationship.

4. The method of claim 2 wherein the predetermined transparency relationship is a linear relationship.

5. The method of claim 2 wherein the predetermined transparency relationship is a power relationship.

6. The method of claim 1 wherein the blending threshold is user-selectable.

7. The method of claim 1 wherein the transparency threshold is user-selectable.

8. The method of claim 1 wherein the blending threshold is fixed.

9. The method of claim 1 wherein the transparency threshold is fixed.

10. The method of claim 1 wherein the first predetermined relationship is that the first pixel is designated to be opaque if the first pixel value is less than the blending threshold.

11. The method of claim 1 wherein the second predetermined relationship is that the first pixel is designated to be transparent if the first pixel value is greater than the transparency threshold.

12. A method for processing a first image comprising a plurality of pixels, the method comprising the steps of:
(a) obtaining the color values of a pixel;
(b) if the color values are in a first predetermined relationship with a blending threshold then designating the pixel to be an opaque pixel;
(c) if the color values are in a second predetermined relationship with a transparency threshold then designating the pixel to be a transparent pixel;
(d) otherwise, designating the pixel to be a partially transparent pixel; and
(e) repeating steps (a) through (d) for at least a second pixel.

13. The method of claim 12 wherein the step of designating the pixel to be a partially transparent pixel comprises selecting a transparency value for the pixel based upon a predetermined transparency relationship for the transparency value with respect to the first value of the pixel and at least one of the blending threshold or the transparency threshold.

14. The method of claim 13 wherein the predetermined transparency relationship is a fixed relationship.

15. The method of claim 13 wherein the predetermined transparency relationship is a linear relationship.

16. The method of claim 13 wherein the predetermined transparency relationship is a power relationship.

17. The method of claim 12 wherein the blending threshold is user-selectable.

18. The method of claim 12 wherein the transparency threshold is user-selectable.

19. The method of claim 12 wherein the blending threshold is fixed.

20. The method of claim 12 wherein the transparency threshold is fixed.

21. The method of claim 12 wherein the first predetermined relationship is that all color values are less than the blending threshold.

22. The method of claim 12 wherein the second predetermined relationship is that all color values are greater than the transparency threshold.

23. A method for combining a first image and a second image, each image comprising a plurality of pixels, the method comprising the steps of:
(a) obtaining a first value of a pixel of the first image;
(b) if the first value is in a first predetermined relationship with respect to a blending threshold then designating the pixel to be an opaque pixel which blocks the corresponding pixel of the second image;
(c) if the first value is in a second predetermined relationship with respect to a transparency threshold then designating the pixel to be a transparent pixel which passes the corresponding pixel of the second image;
(d) otherwise, designating the pixel to be a partially transparent pixel which passes a portion of the corresponding pixel of the second image; and
(e) repeating steps (a) through (d) for at least a second pixel of the first image and the second image.

24. The method of claim 23 wherein the step of designating the pixel to be a partially transparent pixel comprises selecting a transparency value for the pixel based upon a predetermined transparency relationship for the transparency value with respect to the first value of the pixel and at least one of the blending threshold or the transparency threshold.

25. The method of claim 24 wherein the predetermined transparency relationship is a fixed relationship.

26. The method of claim 24 wherein the predetermined transparency relationship is a linear relationship.

27. The method of claim 24 wherein the predetermined transparency relationship is a power relationship.

28. The method of claim 23 wherein the blending threshold is user-selectable.

29. The method of claim 23 wherein the transparency threshold is user-selectable.

30. The method of claim 23 wherein the blending threshold is fixed.

31. The method of claim 23 wherein the transparency threshold is fixed.

32. The method of claim 23 wherein the first predetermined relationship is that the first pixel is designated to be opaque if the first pixel value is less than the blending threshold.

33. The method of claim 23 wherein the second predetermined relationship is that the first pixel is designated to be transparent if the first pixel value is greater than the transparency threshold.

34. A method for combining a first image and a second image, each image comprising a plurality of pixels, the method comprising the steps of:
(a) obtaining the color values of a pixel of the first image;
(b) if the color values are in a first predetermined relationship with a blending threshold then designating the pixel to be an opaque pixel which blocks the corresponding pixel of the second image;
(c) if the color values are in a second predetermined relationship with a transparency threshold then designating the pixel to be a transparent pixel which passes the corresponding pixel of the second image;
(d) otherwise, designating the pixel to be a partially transparent pixel which passes a portion of the corresponding pixel of the second image; and
(e) repeating steps (a) through (d) for at least a second pixel of the first image and the second image.

35. The method of claim 34 wherein the step of designating the pixel to be a partially transparent pixel comprises selecting a transparency value for the pixel based upon a predetermined transparency relationship for the transparency value with respect to the first value of the pixel, the blending threshold, and the transparency threshold.

36. The method of claim 35 wherein the predetermined transparency relationship is a fixed relationship.

37. The method of claim 35 wherein the predetermined transparency relationship is a linear relationship.

38. The method of claim 35 wherein the predetermined transparency relationship is a power relationship.

39. The method of claim 34 wherein the blending threshold is user-selectable.

40. The method of claim 34 wherein the transparency threshold is user-selectable.

41. The method of claim 34 wherein the blending threshold is fixed.

42. The method of claim 34 wherein the transparency threshold is fixed.

43. The method of claim 34 wherein the first predetermined relationship is that all color values are less than the blending threshold.

44. The method of claim 34 wherein the second predetermined relationship is that all color values are greater than the transparency threshold.
